(19) United States
(12) Patent Application Publication
(10) Pub. No.: US 2021/0186244 A1
(43) Pub. Date: Jun. 24, 2021

(54) SYSTEM FOR HOLDING A CANE OR THE LIKE

(71) Applicant: CRESCENT CREATIVE PRODUCTS, LLC, Wheeling, IL (US)

(72) Inventor: Charles Scott Ozmun, Wheeling, IL (US)

(73) Assignee: CRESCENT CREATIVE PRODUCTS, LLC, Wheeling, IL (US)

(21) Appl. No.: 17/128,950

(22) Filed: Dec. 21, 2020

Related U.S. Application Data
(60) Provisional application No. 62/952,555, filed on Dec. 23, 2019.

(51) Int. Cl. A47G 25/12; F16M 13/02; F16B 2/22

(52) U.S. Cl. CPC A47G 25/12; F16B 2/22; F16M 13/022

(57) ABSTRACT

A cane holding assembly for holding a cane. The cane holding assembly includes a main body having a front portion, The cane holding assembly also includes a first arm and a second arm coupled to the front portion and extending away from the front portion. A first end cap is coupled to the first arm at a first arm end opposite the front portion while a second end cap is coupled to the second arm at a second arm end opposite the front portion. The cane holding assembly may also include a first knob coupled to the first arm end and configured to interface with the first end cap. The cane holding assembly may similarly include a second knob coupled to the second arm end and configured to interface with the second end cap.

### CROSS-REFERENCE TO RELATED APPLICATIONS

This application claims priority to and the benefit of U.S. Provisional Patent Application No. 62/952,555, filed Dec. 23, 2019, the content of which is incorporated by reference in its entirety.

### TECHNICAL FIELD

The present disclosure relates generally to systems for a holding non-planar object such as a cane.

### BACKGROUND

Walking canes (walking sticks, hiking sticks, etc.) have been used by many people as mobility aids for ages to facilitate walking. Canes can also be used as a supporting device, fashion accessory, or an object of defense. Based on the purpose of utilization, some canes may be handcrafted from wood, extruded from aluminum, formed of plastics or carbon fiber, or simply a stick from the ground. Aged users generally carry a cane in their hands as a walking aid for support, balance, and mobility. However, the user may need to put the cane down to use their hands to complete an activity such as washing their hands, shaking hands, opening a door, putting on a coat, getting something from a wallet or purse, or similar activities.

During such instances, the user has to make a choice that could impact balance, such as dropping the cane down, finding a supporting object or wall to rest the cane against, or passing the cane to someone else to hold onto.

### SUMMARY

According to a first set on embodiments, a cane holding assembly for holding a cane is provided. The assembly includes a main body having a front portion, a first arm and a second arm coupled to the front portion and extending away from the front portion at a right angle, a first end cap coupled to the first arm at a first arm end opposite the front portion; and a second end cap coupled to the second arm at a second arm end opposite the front portion.

According to a second set of embodiments, a cane holding assembly for holding a cane is provided. The assembly includes a main body having a front portion, a first arm having a first end and a second end opposite the first end, where the first end is coupled to the front portion. The cane holding assembly also includes a first knob coupled to the first arm proximate the second end, and a first end cap rotatably coupled to the first arm proximate the second end.

According to a third set of embodiments, a cane holding assembly for holding a cane is provided. The assembly includes a main body having a front portion and a rear portion cooperating to form a clip, a first arm coupled to the front portion and having a first knob, and a first end cap positioned over the first knob such that the first end cap is rotatable relative to the first arm.

Various embodiments discussed herein provide a simple but effective solution to temporarily hold a cane whenever it is not held in the user's hands. A cane holder may be lightweight, easy to use, portable and easily mountable to accommodate various types of walking canes.

### BRIEF DESCRIPTION OF THE DRAWINGS

FIG. 1 is a perspective view of a cane holding assembly, according to an example embodiment.

FIG. 2 is a side view of the cane holding assembly of FIG. 1.

FIG. 3 is a front view of the cane holding assembly of FIG. 1.

FIG. 4 is a top perspective view of a portion of the cane holding assembly of FIG. 1.

FIG. 5 is a first cross-sectional view of the portion of the cane holding assembly of FIG. 4.

FIG. 6 is a bottom view of the portion of the cane holding assembly of FIG. 4.

FIG. 7 is a perspective bottom view of the portion of the cane holding assembly of FIG. 4.

FIG. 8 is a second cross-section view of the portion of the cane holding assembly of FIG. 4.

FIG. 9 is a partial cross-section view of a portion of the cane holding assembly of FIG. 1.

FIG. 10 is a partial cross-section view of the cane holding assembly of FIG. 1.

FIG. 11 is a top perspective view of a cane holding assembly according to another embodiment.

### DETAILED DESCRIPTION

The present disclosure will now be described fully hereinafter with reference to the accompanying drawings, in which some, but not all aspects of the disclosure are shown. Indeed, the disclosure may be embodied in many different forms and should not be construed as limited to the aspects set forth herein; rather, these aspects are provided so that this disclosure will be thorough and complete, will fully convey the scope of the disclosure to those skilled in the art, and will satisfy applicable legal requirements. Like numbers refer to like elements throughout. As used in this specification and the claims, the singular forms “a,” “an,” and “the” include plural referents unless the context clearly dictates otherwise.

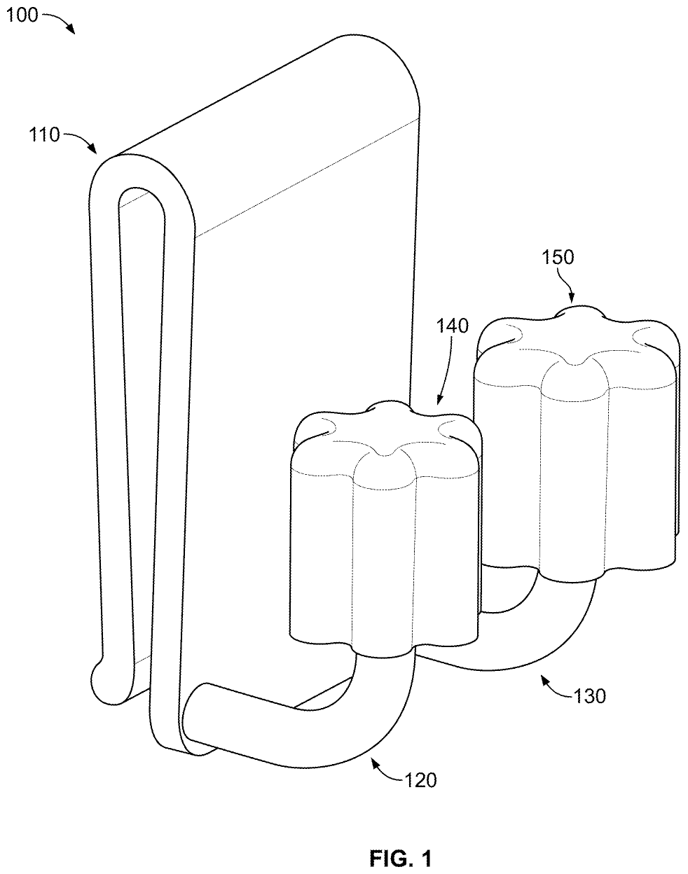

Referring to FIG. 1, a perspective view of a cane holding assembly 100 is shown. The cane holding assembly 100 includes a main body 110, a first arm 120, a second arm 130, a first end cap 140, and a second end cap 150. The cane holding assembly 100 is structured to receive a non-planar object (herein “cane”), such as a cane, a broom handle, a flag stick, a golf club, or any variety of objects having a cylindrical or otherwise non-planar shaft or component. Generally speaking, a cane may be biased toward the main body 110, between the first end cap 140 and the second end cap 150. When the cane is disposed within the cane holding assembly 100, an inherent compliance of the first and second end caps 140, 150 applies a force on the cane in a direction generally toward the main body 110, holding the cane within the cane holding assembly 100. The cane may also be removed from the cane holding assembly 100 by biasing the cane away from the main body 110, between the first and second end caps 140, 150. The inherent compliance of the first and second end caps 140, 150 may apply a force to the cane in a direction generally toward the main body 110 (e.g., against the direction the cane is biased), but the force is not great enough to prevent the cane from being removed (e.g., by a user) from the main body 110, and thus out of and away from the cane holding assembly 100.

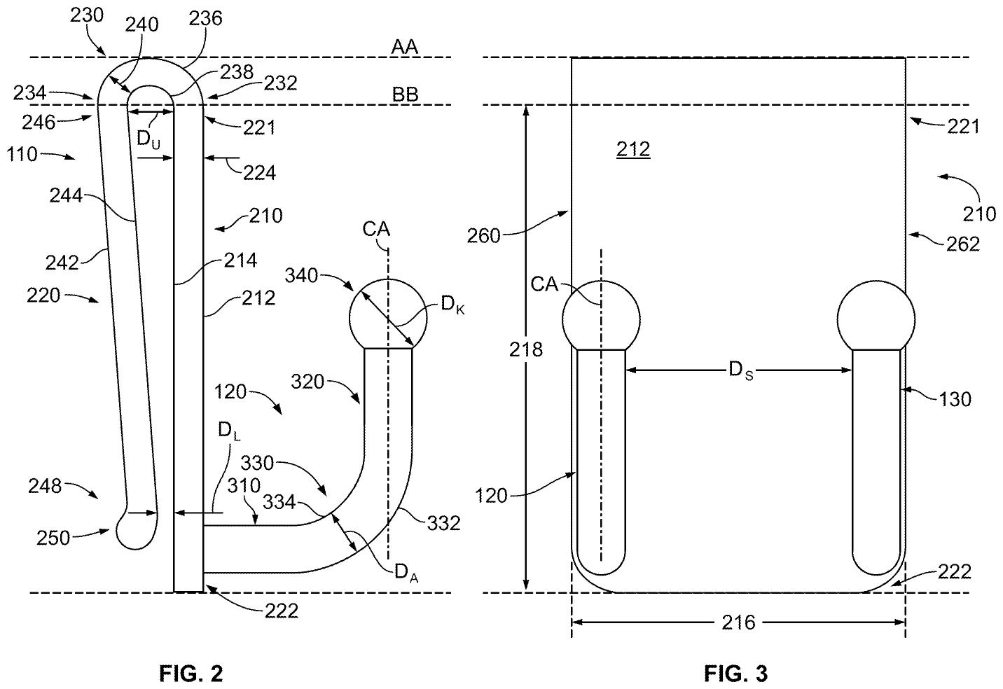

Referring generally to FIGS. 2 and 3, three reference planes are shown. A plane AA is tangent to the highest point. A plane BB, parallel to the plane AA, distinguishes a joint portion of the main body 110 from the front and rear portions. A plane CC is shown, parallel to both plane AA and plane BB, and tangent to the lowest point.

Turning now to FIG. 2, a front view of the cane holding assembly 100 is shown with the first and second end caps 140, 150 removed (e.g., hidden from view). The main body 110 comprises a front (e.g., first) portion 210, a rear (e.g., second) portion 220, and a joint (e.g., third) portion 230. The joint portion 230 is disposed between and joins together the front portion 210 and the rear portion 220. The main body 110 may be a single, integral body formed of a rigid or semi-rigid material, such as plastic, epoxy, resin, thermoset polymers, metal, alloys, wood, glass, and similar materials. In some embodiments, the front portion 210, the rear portion 220, and the joint portion 230 are manufactured separately from one another and later coupled together to form the main body 110. In some embodiments, the main body 110 is manufactured by bending a solid, straight metal bar about a middle section (e.g., near the middle, approximately near the middle, etc.), corresponding to the joint portion 230. In some embodiments, the main body 110 is formed through die-casting, investment casting, injection molding, vacuum forming, or a similar manufacturing process. The main body 110 is configured to receive a generally planar body (herein “waistband’) between the front portion 210 and the rear portion 220, such as a belt (e.g., dress belt), a waistband (e.g., from a pair of pants), a pocket (e.g., pants pocket, rear pocket, shopping cart pocket, pocket on the back of a wheelchair, etc.), the top of a wheelchair back, or similar rigid, semi-rigid, and flexible structures. The main body 110 may be clipped on (e.g., clipped to, slid on, attached to, etc.) the waistband until a top of the waistband interfaces with the joint portion 230. As such, the front portion 210 and the rear portion 220 should be long enough (e.g., extend far enough away from the joint portion 230) such that the main body 110 is difficult to pull laterally away from the waistband, such as by a force applied to either or both of the first arm 120 and the second arm 130.

Referring now to FIG. 3, a front view of the cane holding assembly 100 is shown. The front portion 210 may be generally planar, having a forward facing surface 212 and a rearward facing surface 214, opposite and parallel to the forward facing surface 212. The forward facing surface 212 may be decorative, incorporating an etching, a printed design, or other visually appealing surface finish (e.g., hammered nickel, brushed stainless steel, chrome, etc.). When a cane is biased into the cane holding assembly 100, the cane may interface with the forward facing surface 212. When the main body 110 is clipped onto a waistband, the rearward facing surface 214 may interface with the waistband. The front portion 210 may include a covering (e.g., covering material, sleeve, skin, etc.), such as leather, silicone, rubber, plastic, or PVC. The covering may improve the aesthetic appearance to a user. In some embodiments, the covering may be removable and exchangeable with a different covering. For example, a leather covering may be desirable if the user is in a formal setting, whereas a more rugged silicone covering may be desirable for everyday use. In some embodiments, the covering is permanently added to the front portion 210, such as pliers handle dip (e.g., Plasti Dip®), powder coating, or curable resins and adhesives.

The front portion 210 defines a front portion width 216 and a front portion height 218. The front portion width 216 is between 1 and 2 inches, inclusive, in particular embodiments. In some embodiments, the front portion width is 1.375 inches. In some embodiments, the front portion width 216 may be adjusted to accommodate a cane of most any width or diameter, varying between the diameter of a golf club shaft (0.27″-0.37″) through the diameter of 3″ PVC pipe. The front portion 210 further includes a front upper end 221 and a front lower end 222 opposite the front upper end 221. The front portion 210 is coupled to the joint portion 230 about the front upper end 221. Coupled proximate the front lower end 222 may be the first arm 120 and the second arm 130. The front portion width 216 may be uniform between the front upper end 221 and the front lower end 222. In some embodiments, the front portion width 216 tapers between the front upper end 221 and the front lower end 222, either gradually increasing or gradually decreasing between the two ends 221, 222.

The front portion 210 further defines a front portion thickness 224. The front portion thickness 224 is defined as the distance between the forward facing surface 212 and the rearward facing surface 214. The front portion thickness 224 may be uniform between the front upper end 221 and the front lower end 222. In some embodiments, the front portion thickness 224 tappers between the front upper end 221 and the front lower end 222, gradually decreasing or gradually increasing between the two ends 221, 222. This may be desirable as the front portion thickness 224 may affect the inherent compliance of the front portion 210, which may affect the ease of which a user of the cane holding assembly 100 may attach and remove the main body 110 from a waistband.

The front portion height 218 may be between 1 and 3 inches, inclusive. In some embodiments, the front portion height 218 is between 1.5 and 2.5 inches, inclusive. In other embodiments, the front portion height 218 is 2 inches. The front portion height 218 is defined as the distance between the front upper end 221 and the front lower end 222. In some embodiments, the front portion height 218 is constant across the entirety of the front portion width 216. However, the front lower end 222 may include additional features, such as a bottle opener, a scraper, or similar feature that would cause the front portion height 218 to not be constant (e.g., to have peaks and valleys) across the entirety of the front portion width 216. In such an embodiment, the front portion height 218 may be defined as a maximum distance (e.g., compared to a median or average distance) between the highest point proximate the front upper end 221 and the lowest point proximate the front lower end 222.

As mentioned above, the front portion 210 is coupled to the joint portion 230 about the front upper end 221. The joint portion 230 defines a first joint end 232 coupled to the front upper end 221, and a second joint end 234 coupled to the rear portion 220, the second joint end 234 opposite the first joint end 232. The joint portion 230 further defines a generally arced geometry, having an extrados surface 236 and an intrados surface 238. In some embodiments, the extrados surface 236 and the intrados surface 238 are generally parallel. In some embodiments, the extrados surface 236 and the intrados surface 238 each define a hemi-circle geometry and are concentric about each other when the cane holding assembly 100 is viewed from either the right side or the left side. A joint thickness 240 is defined as a distance between the extrados surface 236 and the intrados surface 238. The joint thickness 240 may be equal to, slightly greater than, or slightly less than the front portion thickness 224. Generally speaking, the exact geometry of the joint portion 230 may not be materially relevant to the functionality of the joint portion 230. For example, a profile of the joint portion 230, when viewed from the side, may resemble a rectangle (e.g., may have two right angles instead of one continuous arch joining the front portion 210 to the rear portion 220). In some embodiments, the joint portion 230 is formed of a semi-rigid or flexible material different from the front portion 210 and/or the rear portion 220. For example, the joint portion 230 may be formed of a polymer or an elastomer overmolded to both the front upper end 221 and the rear portion 220. In some embodiments, the joint portion 230 may be formed of a metal alloy, having an inherent compliance. The joint portion 230 functions to allow the front portion 210 and the rear portion 220 to move (e.g., translate, bias, flex, etc.) relative to each other. When the main body 110 is clipped to a waistband, the rear portion 220 may bias away from the front portion 210 such that the waistband can fit between the front portion 210 and the rear portion 220. The joint portion 230 may allow such movement of the front portion 210 and the rear portion 220 to occur. Once the main body 110 is clipped to the waistband, the joint portion 230 may facilitate movement of the rear portion 220 toward the front portion 210, effectively pinching the waistband between the front portion 210 and the rear portion 220. Changing the material properties of the joint portion 230, such as changing the material, the thickness, or the geometry may alter the compressive force exerted by the front portion 210 and the rear portion 220 on the waistband when the main body 110 is clipped onto the waistband.

The rear portion 220 is similar to the front portion 210. A difference between the rear portion 220 and the front portion 210 is that the rear portion 220 includes a flange, shown as a release flange 250. The rear portion 220 may include a covering similar to the covering of the front portion 210. In some embodiments, the covering may be removable and exchangeable with a different covering. In some embodiments, the covering may cover the rear portion 220, the joint portion 230, and the front portion 210 at the same time. The rear portion 220 is generally planar and includes a rear back surface 242 and a rear front surface 244 opposite and parallel to the rear back surface 242. The rear front surface 244 faces the rearward facing surface 214. When the main body 110 is clipped on a waistband, the rear front surface 244 interfaces with the waistband. The rear portion 220 also includes a rear upper end 246 and a rear lower end 248 opposite the rear upper end 246. The rear upper end 246 is coupled to the joint portion 230. As shown in FIG. 2, the rear lower end 248 is positioned above the front lower end 222. In some embodiments, the rear portion 220 extends below the front portion 210 such that the rear lower end 248, and thus the release flange 250, is positioned below the front lower end 222. In some embodiments, the rear lower end 248 and the front lower end 222 are both positioned the same distance away from the joint portion 230 (e.g., both the rear lower end 248 and the front lower end 222 are positioned the front portion height 218 from the joint portion 230).

The main body 110 further defines a distance between the rear upper end 246 and the front upper end 221. More specifically, the main body 110 defines a distance between the rear front surface 244 proximate the rear upper end 246 and the rearward facing surface 214 proximate the front upper end 221. This distance is shown as an upper clearance distance D_{U}. The upper clearance distance D_{U} is structured to accommodate most sized belts and waistbands. The main body 110 may to clip onto a waistband having a thickness approximately equal to or slightly less than the upper clearance distance D_{U}. In some embodiments, the joint portion 230 allows the rear portion 220 to separate from the front portion 210 enough to accommodate a waistband having a thickness greater than the upper clearance distance D_{U}. In some embodiments, the upper clearance distance D_{U} is between 0.1 inches and 1 inch. In other embodiments, the upper clearance distance D_{U} is between 0.2 inches and 0.5 inches. In even other embodiments, the clearance distance is 0.25 inches.

The rear portion 220 and the front portion 210 may be parallel to one another as each of the front portion 210 and the rear portion 220 extend away from the joint portion 230, maintaining the upper clearance distance D_{U} between the front portion 210 and the rear portion 220 over the entirely of the front portion height 218. However, as shown in FIG. 3, the rear portion 220 may extend from the joint portion 230 in a direction generally toward the front portion 210 (e.g., the front portion 210 and the rear portion 220 are not parallel to one another). Thus, another distance is defined between the rear lower end 248 and the front lower end 222. More specifically, a distance, shown as a lower clearance distance D_{L}, is shown as a distance between the rear front surface 244 proximate the rear lower end 248, and the rearward facing surface 214 proximate the rear lower end 248. The lower clearance distance may be less than the upper clearance distance. This may be desirable as this allows the main body 110 to clip onto waistbands having a thickness less than the upper clearance distance D_{U}. In some embodiments, the lower clearance distance D_{L} may be zero, meaning that the rear lower end 248 is contacting the front portion 210. This may be desirable for clipping onto very thin waistbands. When the main body 110 is clipped to a waistband, the rear lower end 248 is biased away from the front portion 210 such that the waistband can slide between the rear portion 220 and the front portion 210. When clipped, the inherent compliance of the joint portion 230 may bias the rear lower end 248 toward the front portion 210, pinching the waistband in between. It should be understood that each of the front portion 210 and the rear portion 220 may also exhibit an inherent compliance. For example, if the joint portion 230 were incredibly rigid (e.g., formed of ceramic or glass), the inherent compliance of the front portion 210 and the rear portion 220 may allow the waistband to bias the rear portion 220 from the front portion 210 when sliding the main body 110 onto the waistband, and the inherent compliance of the front portion 210 and the rear portion 220 may also bias the rear portion 220 toward the front portion 210 to pinch the waistband in between. In some embodiments, such as embodiment where the joint portion 230 is formed of a semi-rigid material exhibiting inherent compliance, the front portion 210 and the rear portion 220 may also exhibit inherent compliance.

To help facilitate disposing the main body 110 onto a waistband, the rear portion 220 may include the release flange 250 positioned proximate the rear lower end 248. The release flange 250 extends from the rear portion 220 in a direction generally away from the front portion 210. The release flange 250 make it easier for a user of the cane holding assembly 100 to attach the main body 110 to a waistband.

To further facilitate disposing the main body 110 onto a waistband, the rear portion 220 may include a horizontal projection (e.g., horizontal rib, rib, etc.). More specifically, a horizontal projection may extend away from the rear front surface 244 in a direction generally toward the front portion 210. The horizontal projection may grip the waistband when the main body 110 is clipped to the waistband, increasing the amount of force required to remove the main body 110 from the waistband. The rear portion 220 may include one, two, or more horizontal projections. Similarly, the front portion 210 may include a horizontal projection. Specifically, the rearward facing surface 214 may include a horizontal projection extending in a direction generally toward the rear portion 220. In some embodiments, both the front portion 210 and the rear portion 220 include a horizontal projection, and the two horizontal projections may cooperate with each other to interface with the waistband and grip the waistband. In some embodiments, the horizontal projection is a series of small teeth that grip to the waistband when the main body 110 is clipped to a waistband.

In some embodiments, the cane holding assembly 100 may be coupled (e.g., fixed, secured, mounted, etc.) to a wall (e.g., vertical or near-vertical surface). For example, the main body 110 may include a hole (e.g., orifice) configured to accept a fastener (e.g., bolt, screw, nail, etc.). In some embodiments, the main body 110 is structured to slide onto the top of a door. In such embodiments, it may be desirable for the joint portion 230 to be thin enough to slide between a door and the top of the door frame so as to not damage either the door or the door frame when the door opens and closes. Further, it may be desirable in particular implementations for the upper clearance distance D_{U} to be approximately the same as a thickness of the door. In some embodiments, the rear back surface 242 is coupled to a wall using an adhesive, such as double-stick tape, 3M Command Strips, super glue, or similar adhesives. In some embodiments, the main body 110 only includes the front portion 210 such that the rearward facing surface 214 is coupled to the wall. In some embodiments, the joint portion 230 is removably coupled to the front portion 210 such that a user of the cane holding assembly 100 may switch between the main body 110 defining a clip and the main body 110 being mountable to a wall.

Referring now to FIG. 3, the first arm 120 and the second arm 130 are shown coupled to the front portion 210 proximate the front lower end 222. As shown, the first arm 120 is coupled to the front portion 210 just above the front lower end 222 such that a portion of the front portion 210 extends below where the first arm 120 is coupled. In some embodiments, the first arm 120 may be coupled to the front portion 210 at the front lower end 222 such that no portion of the front portion 210 extends below the first arm 120. In some embodiments, the first arm 120 may be coupled to the front portion 210 anywhere along the front portion height 218 and the front portion width 216. The same is true for the second arm 130. In some embodiments, the first arm 120 and the second arm 130 are coupled at the same height along the front portion height 218.

The front portion 210 is shown as defining a front portion first side 260 and a front portion second side 262. The first arm 120 is coupled proximate the front portion first side 260 and the second arm 130 is coupled proximate the front portion second side 262. As shown, the front portion first side 260 and the front portion second side 262 are parallel to and opposite one another. However, as mentioned before, the front portion width 216 may change between the front upper end 221 and the front lower end 222. The lower corners of the front portion 210 may be sharp or curved (e.g., an interface between the front lower end 222 and the front portion sides 260, 262 may be square or rounded).

The first arm 120 and the second arm 130 may be separated by a distance, shown as a separation distance D_{S}. The separation distance D_{S} is structured to provide enough clearance to accept most sizes of canes. In some embodiment, the separation distance D_{S} is between 0.5 inches and 2 inches, inclusive. In other embodiments, the separation distance D_{S} is between 0.5 inches and 1.25 inches, inclusive. In still other embodiments, the separation distance D_{S} is 1.2 inches.

Turning now to FIG. 3, the first arm 120 has a first arm first portion 310, a first arm second portion 320, and a first arm joint portion 330, each shown as being separated by dotted lines. The first arm first portion 310 is coupled to the front portion 210 and projects away from the forward facing surface 212. In some embodiments, the first arm first portion 310 projects away from the front portion 210 at a right angle. The first arm first portion 310 extends away from the front portion 210 until it joins the first arm joint portion 330. The first arm joint portion 330 is contiguous with the first arm first portion 310. The first arm joint portion 330 defines a first arm joint extrados 332 and a first arm joint intrados 334. Generally speaking, the first arm joint portion 330 facilitates a 90 turn in the first arm 120, eventually joining the first arm second portion 320. The first arm second portion 320 extends in a direction generally away from the first arm joint portion 330 and alone a central axis CA. In some embodiments, the central axis CA is parallel to the front portion 210 and perpendicular to the first arm first portion 310. A length of the first arm first portion 310 is approximately equal to a length of the first arm second portion. Disposed at an end of the first arm second portion 320, opposite the first arm joint portion 330, is a spherical body, shown as a first knob 340. The first knob 340 may be coupled to the end of the first arm second portion 320 by welding, fasteners, or manufactured to be integral with the first arm 120.

The first arm 120 is defined by a generally cylindrical cross-section, defining a first arm diameter D_{A}. The first arm diameter D_{A} may be between 0.1 inches and 0.5 inches, inclusive. The first arm diameter D_{A} may be 0.25 inches. Each of the first arm first portion 310, the first arm second portion 320, and the first arm first portion 310 may have cross-sections defining slightly different diameters from the first arm diameter D_{A}. In some embodiments, a diameter of the first arm joint portion 330 is slightly less than the first arm diameter D_{A}, which may be a results of bending the first arm 120 about the first arm joint portion 330 to direct the first arm second portion 320 along the central axis CA. When a cane is inserted into the cane holding assembly 100, the cane exerts a force on the first arm 120 in a direction toward the front portion first side 260. Thus, it may be desirable that the first arm 120 be formed of a material able to handle the force without permanently deforming or breaking; some compliance in the first arm 120 is okay. For example, similar to the joint portion 230, the first arm joint portion 330 may be manufactured of a polymer or elastomer and overmolded to the first arm first portion 310 and the first arm second portion 320. This would allow the first arm 120 to be compliant without damaging the first arm 120. Alternatively, the first arm first portion 310 may be manufactured from an elastomer or polymer having compliance. Since the stresses on the first arm 120 will concentrate proximate where the first arm first portion 310 is coupled to the front portion 210, it may be desirable in certain embodiments to make the first arm diameter D_{A} greater at this coupling point, and taper the first arm diameter D_{A} of the first arm first portion 310 to be smaller proximate the first arm joint portion 330.

The first knob 340 may define a diameter, shown as a knob diameter D_{K}, greater than the first arm diameter D_{R}. More specifically, the knob diameter D_{K} is greater than the first arm radius D_{R} of the first arm second portion 320. The first knob 340 is positioned within the first end cap 140 and configured to interface with the first end cap 140, cooperating with the first end cap 140 to allow rotation of the first end cap 140 about the first arm second portion 320 (e.g., about the central axis CA) without allowing axial motion of the first end cap 140 in a direction generally away from the first arm joint portion 330 and along the central axis CA.

The second arm 130 is similar to the first arm 120. A difference between the first arm 120 and the second arm 130 is that the first arm 120 is positioned nearer the front portion first side 260, while the second arm 130 is positioned nearer the front portion side surface 262. Similar to the first arm 120, the second arm 130 is also defined by a central axis CA.

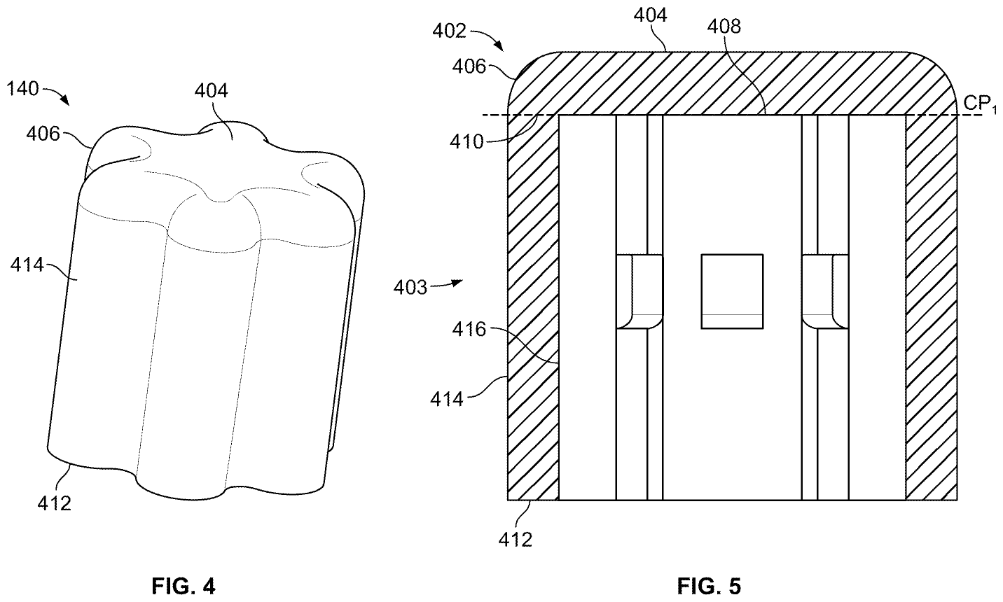

Referring to FIG. 4, a top perspective view of the first end cap 140 (e.g., the second end cap 150) is shown. The first end cap 140 may be formed of an elastomer, rubber, latex, or other similarly compliant material. FIG. 5 shows a cross-sectional side view of the first end cap 140. The first end cap 140 is shown as having an upper cap portion 402 and a lower cap portion 403, separated by a plane, shown as cap plane CP₁. The upper cap portion 402 and the lower cap portion 403 cooperate to define the first end cap 140. The upper cap portion 402 includes an upper portion top surface 404, an upper portion side surface 406, and an upper portion bottom surface 408. As shown in FIG. 4, the upper portion top surface 404 defines a shape approximate to a regular hexagram having rounded points (e.g., shape similar to the Star of David with rounded points). However, the upper portion top surface 404 may define many other polygon shapes, such as a hexagon, a star, a pentagon, a circle, a triangle, and so on.

The upper portion bottom surface 408 is parallel to and opposite the upper portion top surface 404 and may defined a similar shape to the upper portion top surface 404. Further, the upper portion bottom surface 408 lies on the cap plane CP₁. Extending between and contiguous with the upper portion top surface 404 and the upper portion bottom surface 408 is the upper portion side surface 406. The upper portion side surface 406 may taper between the upper portion top surface 404 and the upper portion bottom surface 408. For example, if the upper portion top surface 404 defines a first shape having a first diameter and the upper portion bottom surface 408 defines the first shape having a second perimeter larger than the first (e.g., the shapes are similar, but are scaled), then the upper portion side surface 406 may taper from the first perimeter of the upper portion top surface 404 to the second perimeter of the upper portion bottom surface 408 while maintaining a cross-section of a shape similar to the first shape. In some embodiments, the upper portion side surface 406 meets the upper portion top surface 404 at a sharp (e.g., 90 degree) corner. In some embodiments, the upper portion side surface 406 meets the upper portion bottom surface 408 at a sharp corner.

Coupled to the upper cap portion 402 is the lower cap portion 403. In some embodiments, the upper cap portion 402 and the lower cap portion 403 are integrally formed with one another, such as through casting, injection molding, 3D printing, or similar manufacturing processes. The lower cap portion 403 includes a lower portion top surface 410, a lower portion bottom surface 412, the outer cap surface 414, and the inner cap surface 416. In some embodiments, the lower portion top surface 410 and the lower portion bottom surface 412 define the same shape, the same inner perimeter, and the same outer perimeter such that a horizontal cross-section of the lower cap portion 403 is the same proximate the lower portion top surface 410 as it is proximate the lower portion bottom surface 412. In some embodiments, the first end cap 140 tapers inward or outward from the lower portion top surface 410 to the lower portion bottom surface 412. The outer perimeter of the lower portion top surface 410 may exactly match the perimeter of the upper portion bottom surface 408 such that the upper portion side surface 406 is contiguous with and continuously transitions to the outer cap surface 414.

The lower portion bottom surface 412 may be the first shape, similar to the shape of the upper portion top surface 404. In some embodiments, the lower portion bottom surface 412 defines a different shape from the upper portion top surface 404. For example, the upper portion top surface 404 may define a regular hexagram having rounded points, as shown in FIG. 4. But the lower portion bottom surface 412 have a different shape, such as a circle. The first end cap 140 may taper and change horizontal cross-sections between the upper portion top surface 404 and the lower portion bottom surface 412, allowing the upper portion top surface 404 and the lower portion bottom surface 412 to define different shapes (e.g., profiles, perimeters, etc.)

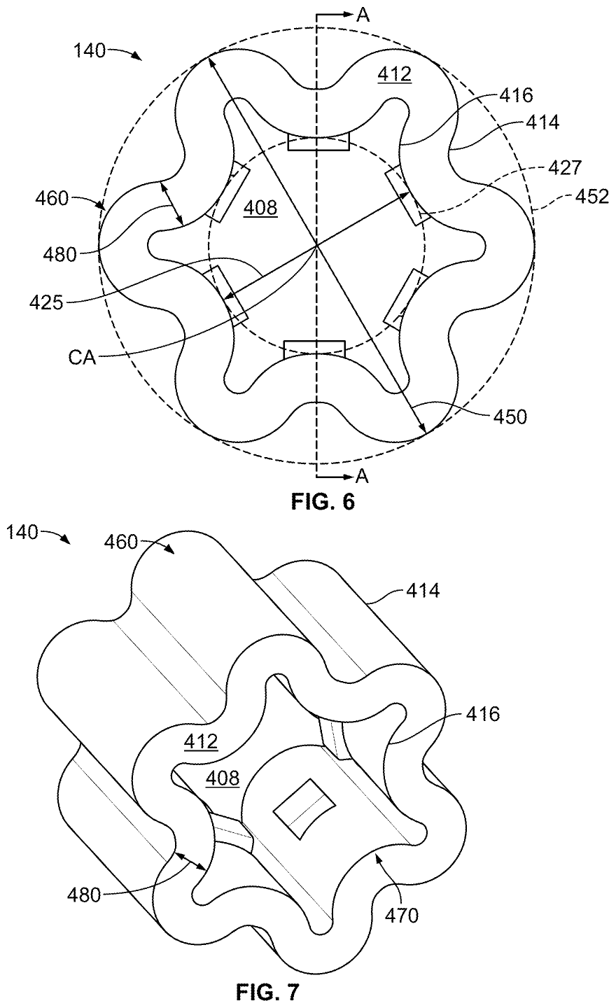

Turning now to FIG. 6, a bottom view of the first end cap 140 is shown. As shown, the first end cap 140 defines two diameters: an inner diameter 425 and an outer diameter 450. The inner diameter 425 is defined by an inner circle 427, the inner circle 427 defined by connecting at least 3 of the innermost points (e.g., points nearest the central axis CA) of the inner cap surface 416 proximate the lower portion bottom surface 412 to form the inner circle 427. Where the first end cap 140 maintains a constant cross-section between the lower portion bottom surface 412 and the lower portion top surface 410, the inner diameter 425 and the inner circle 427 are also maintained. As shown, the first end cap 140 includes six innermost points corresponding to six valleys, the six points lying on the inner circle 427. Similarly, the outer diameter 450 is defined by an outer circle 452, the outer circle 452 formed by connecting at least 3 outmost points (e.g., points furthest positioned from the central axis CA) of the outer cap surface 414. It should be appreciated that between the inner circle 427 and the outer circle 452, the first end cap 140 may take many different forms, from being a cylinder to being a 100-point star. Generally speaking, the knob diameter D_{K} is approximately equal to the inner diameter 425 such that the first end cap 140 may be placed on the first knob 340, and the first knob 340 allowed to interface with the inner cap surface 416 and the upper portion bottom surface 408.

Referring still to FIG. 6, the first end cap 140 is shown as including a plurality of teeth extending between the upper portion top surface 404 and the lower portion bottom surface 412. One of the plurality of teeth, shown as an outer cap tooth 460, is shown in FIG. 7 as extending in a direction generally away from a central axis CA. The outer cap tooth 460 may define an outer cap tooth extrados, rounded or sharply cornered proximate the outer cap surface 414. In some embodiments, the outer cap tooth 460 includes small projections or texturing, such as ribs or bumps at the extrados of the outer cap tooth 460, which may improve the interface between the first end cap 140 and a cane. The first end cap 140 is shown as having six teeth, each outer cap tooth 460 positioned about a perimeter of the first end cap 140 and spaced at equidistant intervals from one another such that the first end cap 140 exhibits radial symmetry (e.g., looks the same when viewed from above/below/the side at 0 degrees about the central axis CA as the first end cap 140 looks when viewed from the same perspective at 60 degrees, 120 degrees, 180 degrees, 240 degreed, 300 degrees, and 360 degrees about the central axis CA). In some embodiments, the first end cap 140 has five teeth spaced evenly about the perimeter of the first end cap 140, exhibiting rotational symmetry every 72 rotational degrees about the central axis CA. In some embodiments, the first end cap 140 may have other numbers of cap teeth (13, 17, 23, etc.). In some embodiments, the first end cap 140 has no cap teeth (e.g., the first end cap 140 is a cylindrical body).

In some embodiments, the horizontal cross-section of the first end cap 140 proximate the upper portion top surface 404 changes slightly by becoming smaller than the cross-section of the lower cap portion 403. As a result, the outer cap tooth 460 narrows proximate the upper portion top surface 404 and represents a shape similar to a silo or a bullet. The outer cap surface 414 may be contiguous about the perimeter of the first end cap 140, such that each cap tooth is contiguous with each other cap tooth. In some embodiments, the outer cap tooth 460 is integrally formed with the first end cap 140 during manufacturing, such as through injection molding, die-casting, milling, assistive manufacturing, or similar manufacturing processes.

Referring now to FIG. 7, a bottom perspective view of the first end cap 140 is shown. The inner cap surface 416 and the upper portion bottom surface 408 cooperate to define a cavity within the first end cap 140. The first end cap 140 is also shown as having a variety of inner cap teeth, one of the inner cap teeth shown as inner cap tooth 470. The inner cap tooth 470 is similar to the outer cap tooth 460. The inner cap tooth 470 extends toward the central axis CA and helps to define the inner circle 427 (e.g., the points defining the inner circle 427 are positioned on an extrados of the inner cap teeth). The inner cap tooth 470 corresponds to a valley of the outer cap surface 414, while the outer cap tooth 460 corresponds to a valley of the inner cap surface 416. The number of outer cap teeth may correspond to a number of inner cap teeth (e.g., the first end cap 140 may have the same number of inner cap teeth as outer cap teeth). In some embodiments, the inner cap teeth and outer cap teeth are simply projected features extending away from the outer cap surface 414 and the inner cap surface 416 and do not structurally correspond to each other.

The first end cap 140 further defines a cap thickness 480, defined as the distance between the outer cap surface 414 and the inner cap surface 416. In some embodiments, the first end cap 140 is the same thickness about a perimeter of the first end cap 140 (e.g., the cap thickness proximate the lower portion bottom surface 412 is the same about the entire perimeter). In some embodiments, the cap thickness 480 is the same extending between the upper portion top surface 404 and the lower portion bottom surface 412. In some embodiments, the cap thickness 480 is different at different points along the perimeter of the first end cap 140. For example, the portions of the first end cap 140 positioned furthest from the central axis CA (e.g., an extrados of the outer cap tooth 460, a peak) may have a thickness slightly less than the cap thickness 480 of the portions of the first end cap 140 nearest the central axis CA (e.g., an extrados of the inner cap tooth 470, a valley). In some embodiments, it may be desirable to change the cap thickness 480 of the first end cap 140 proximate the extrados of the outer cap tooth 460 to adjust the compliance of the first end cap 140, and thus adjust a force required to insert a cane into the cane holding assembly 100 and a force to remove the cane from the cane holding assembly 100. A lesser cap thickness proximate the extrados of the outer cap tooth 460 may increase the compliance of the first end cap 140, making it easier (e.g., requiring less force) to insert and remove a cane from the cane holding assembly 100.

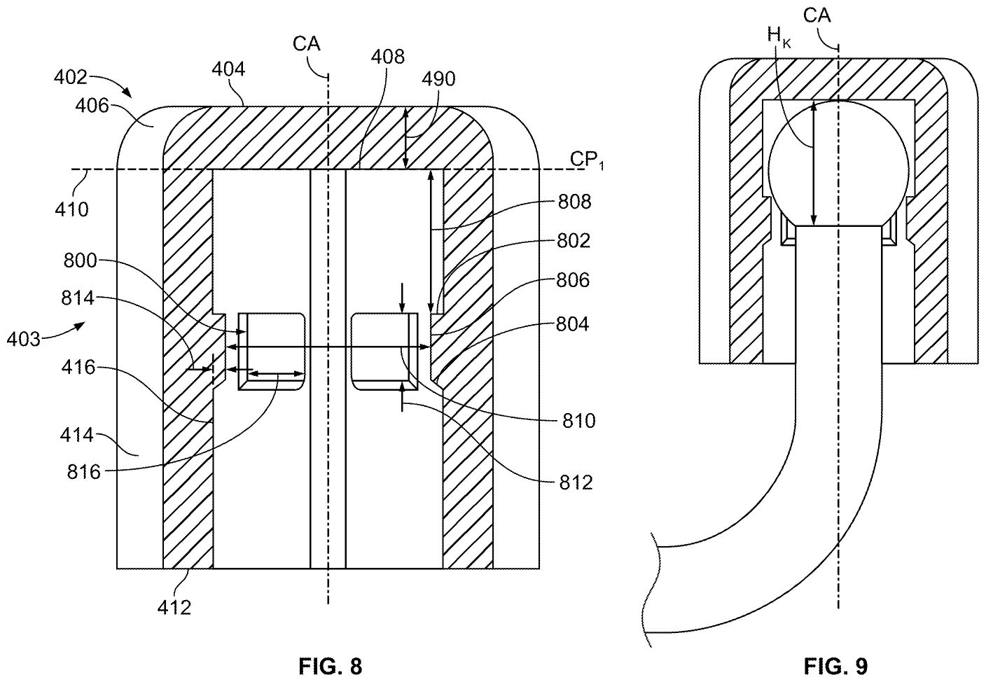

Turning now to FIG. 8, a side-view of a cross-section of the first end cap 140 is shown about broken line A from FIG. 6. Proximate the upper portion top surface 404 is a top cap thickness 490, defined as the distance between the upper portion top surface 404 and the upper portion bottom surface 408. The top cap thickness 490 may be equal to, greater than, or less than the cap thickness 480.

The first end cap 140 also includes projections extending toward the central axis CA from the inner cap surface 416, one of the projections shown as a cap projection 800. The cap projection 800 may be integrally formed with the first end cap 140. In some embodiments, the cap projection 800 is formed separately and later coupled to the first end cap 140 by overmolding, welding, fasteners, adhesive, or similar manufacturing processes. The cap projection 800 is positioned at the extrados of the inner cap tooth 470. Referring generally to the FIGS., each inner cap tooth 470 includes a projection positioned proximate an apogee of the extrados of the inner cap tooth 470. The cap projection 800 includes a top projection surface 802, a bottom projection surface 804, and a front projection surface 806. The top projection surface 802 is contiguous with the inner cap surface 416 and may be parallel to the upper portion bottom surface 408 and the upper portion top surface 404. The top projection surface 802 is positioned away from the upper portion bottom surface 408 by a distance, shown as a knob clearance distance 808. Speaking generally, the knob clearance distance 808 is less than the knob diameter D_{K}. The top projection surface 802 is structured to interface with the first knob 340 to prevent the first end cap 140 from moving axially along the central axis CA in a direction generally away from the first arm 120. The front projection surface 806 is contiguous with the top projection surface 802 and may be perpendicular to the upper portion bottom surface 408 and the upper portion top surface 404.

Each of the six projections cooperate to define a projection diameter 810. The projection diameter 810 is defined by a circle formed by connecting the innermost (e.g., closest to the central axis CA) point of each of the six projections. In some embodiments, where the six projections are not radially spaced so as to form a circle, the projection diameter 810 may instead be the distance separating two projections opposite from one another. Thus, in an embodiment where the first end cap 140 includes six projections, there may be three projection diameters 810a, 810b, and 810c, each different in length from the next (not shown). The bottom projection surface 804 is contiguous with both the front projection surface 806 and the inner cap surface 416.

The bottom projection surface 804 may be parallel to the top projection surface 802. In some embodiments, the bottom projection surface 804 is a tapered transition surface (e.g., a ramped surface) between the front projection surface 806 and the inner cap surface 416. The bottom projection surface 804 may taper away from the front projection surface 806 in a direction generally toward the inner cap surface 416. The cap projection 800 is defined by a projection height 812, a projection thickness 814, and a projection width 816. In some embodiments, the projection height 812 is equal to the projection width 816. In some embodiments, the projection height 812 is less than the projection width 816.

Turning now to FIG. 9, the first end cap 140 is shown cut away, showing the first arm 120 and the first knob 340 disposed within. The first knob 340 is defined by the knob diameter D_{K} and a knob height H_{K}. In some embodiments, a bottom of the first knob 340 is flattened, causing the knob height H_{K} to be less than the knob diameter D_{K}. In some embodiments, the inner diameter 425 of the first end cap 140 is equal to the knob diameter D_{K} such that when the first end cap 140 is slid over the first knob 340, an outer surface of the first knob 340 interfaces with the inner cap surface 416. When the first knob 340 is inserted into the first end cap 140, the first knob 340 will eventually interface with the cap projection 800 (e.g., the six projections). As the projection diameter 810 is less than the inner diameter 425, the projection diameter 810 is also less than the knob diameter D_{K}. In such an embodiment, the first knob 340 will interface with the bottom projection surface 804. The rounded outside of the first knob 340 will bias the bottom projection surface 804, and thus the cap projection 800, outward in a direction generally away from the central axis CA. The compliance of the first end cap 140 allows for the cap projection 800 to be biased away from the central axis CA. In some embodiments, the first end cap 140 may be manufactured from a rigid material while the first knob 340 is manufactured from a compliant material. In such an embodiment, the cap projection 800 will instead bias the outer surface of the first knob 340 in a direction generally toward the central axis CA.

As the first knob 340 is further inserted into the first end cap 140, the first knob 340 will slide along the front projection surface 806 until the first knob 340 interfaces with the upper portion bottom surface 408. In the embodiment where the knob diameter D_{K} is equal to the inner diameter 425, the first knob 340 will interface with the upper portion bottom surface 408 and the inner cap surface 416 at the same time. In some embodiments, the projection thickness 814 will be optimized such that the first knob 340 interfaces with the upper portion bottom surface 408, the inner cap surface 416, and the cap projection 800 at the same time.

In some embodiments, the knob diameter D_{K} will be less than the inner diameter 425, but greater than the projection diameter 810. Thus, when the first knob 340 is inserted into the first end cap 140 and interfacing with the upper portion bottom surface 408, the first knob 340 may be positioned such that there is clearance between the first knob 340 and the inner cap surface 416. During use, the inner cap surface 416 and the first knob 340 would interface.

In some embodiments, the first knob 340 has a knob diameter D_{K} greater than the inner diameter 425, or smaller than the projection diameter 810.

The first end cap 140 is similar to the second end cap 150. In some embodiments, the first end cap 140 and the second end cap 150 are identical. The end caps 140, 150 may also be interchangeable.

In some embodiments, the first end cap 140 is manufactured to be rotatably coupled to the first knob 340 but not removable from the first knob 340. For example, the cap projection 800 (e.g., the cap projections) may be fixed at the projection diameter 810 such that the cap projection 800 may not be biased away from the central axis CA, and the first knob 340 may be formed of a rigid material that will not bias toward the central axis CA. In such an embodiment, the first end cap 140 may not be removed from the first knob 340 without permanently damaging (e.g., plastically deforming) a component of the cane holding assembly 100. In some embodiments, the inner cap surface 416 may be formed of a rigid material, such as steel or plastic. The cap projection 800 may be coupled to the inner cap surface 416 such that the cap projection 800 may not be biased in a direction generally away from the central axis CA. The rest of the first end cap 140 (e.g., the outer cap surface 414, etc.) may be formed of a compliant material such that a cane may still be inserted into and removed from the cane holding assembly 100. When the cane is either inserted into or removed from the cane holding assembly 100 the first end cap 140 (e.g., the second end cap 150) may rotate about the first arm 120 (e.g., the second arm 130, the central axis CA)

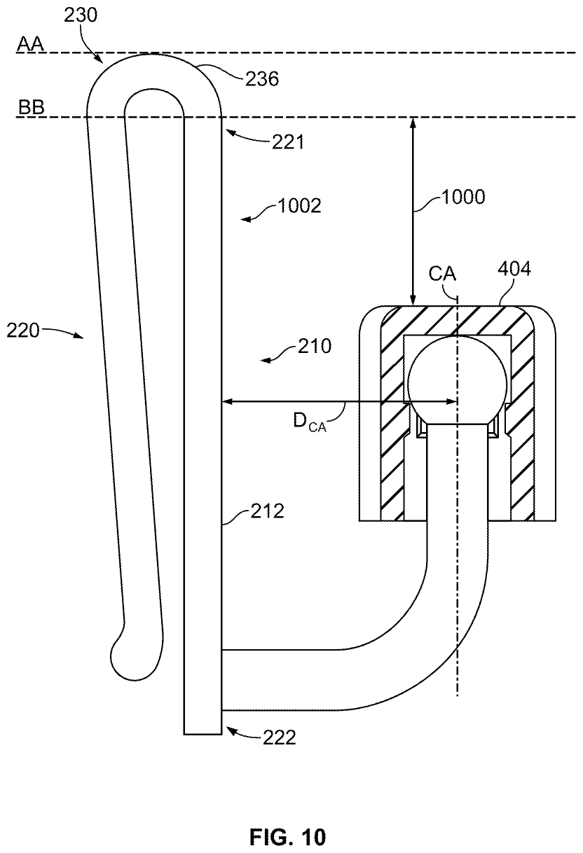

Turning now to FIG. 10, a side view of the cane holding assembly 100 is shown, the first end cap 140 cut away to show the first knob 340. As a reference, a plane AA is shown, tangent to an apogee of the extrados surface 236 of the joint portion 230. Also shown is a plane BB, parallel to the plane AA and intersecting a point that lies between the front portion 210 and the joint portion 230. And also, a plane CC is shown, parallel to both plane AA and plane BB, and tangent to the front lower end 222. A distance 1000 is shown as being a distance from the plane BB to the upper portion top surface 404. In some embodiments, the front portion 210 extends above the upper portion top surface 404. The portion of the front portion 210 that extends above the upper portion top surface 404 is shown as a shield portion 1002 (e.g., buffer portion, protection portion, contact plate portion, etc.). When a cane is inserted into the cane holding assembly 100 and clipped to a waistband, a portion of the cane (such as a handle) may be positioned above the upper portion top surface 404. The shield portion 1002 serves to protect the waistband from being contacted (e.g., rubbed, scratched, snagged, cut, etc.) by the cane or other object inserted into the cane holding assembly 100. In some embodiments, the upper portion top surface 404 is disposed approximately half way between the front lower end 222 and the front upper end 221. In some embodiments, the upper portion top surface 404 is positioned neared the front lower end 222 than the front upper end 221. In some embodiments, the upper portion top surface 404 is positioned nearer the front upper end 221 than the front lower end 222.

Similarly positioned is the first knob 340. A position of the first knob 340 is referenced by a center of the first knob 340 (e.g., a center of the first knob 340 if the first knob were a complete sphere). The shape and dimensions of the first arm 120 may be adjusted such that the center of the first knob 340 is positioned approximately half-way between the front lower end 222 and the front upper end 221. In some embodiments, the center of the first knob 340 is positioned nearer the front lower end 222 than the front upper end 221. In some embodiments, the center of the first knob 340 is positioned nearer the front upper end 221 than the front lower end 222. A distance separates the central axis CA, and thus the first knob 340, from the front portion 210, the distance shown as an axis separation distance D_{CA}. The axis separation distance D_{CA} may be between 0.25 and 0.5 inches, inclusive. In some embodiments, the axis separation distance D_{CA} is between 0.3 and 0.4 inches, inclusive. In some embodiments, the axis separation distance D_{CA} is 0.375 inches.

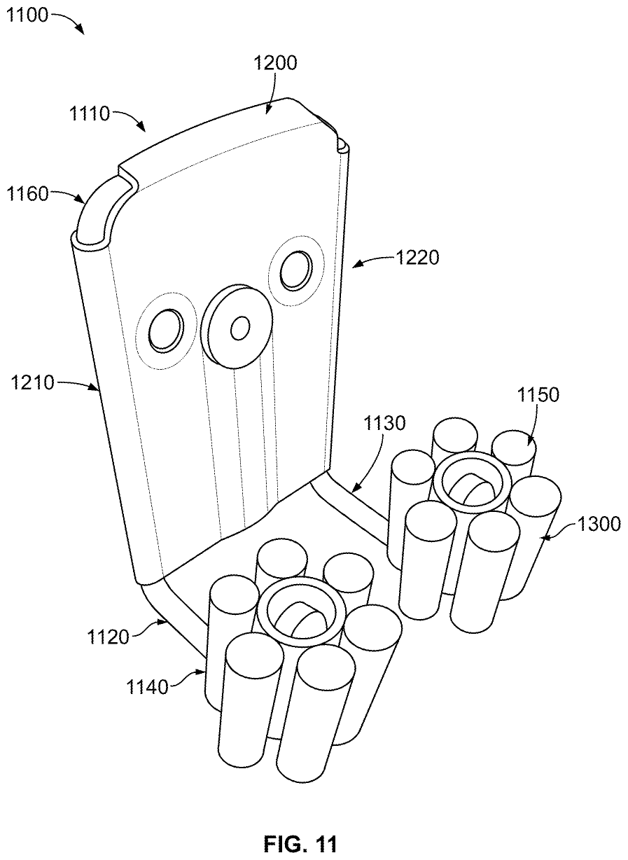

Referring now to FIG. 11, a perspective view of another embodiment of a cane holding assembly in shown as a cane holding assembly 1100. The cane holding assembly 100 is similar to the cane holding assembly 1100. The cane holding assembly 1100 includes a main body 1110, a first arm 1120, a second arm 1130, a first end cap 1140, and a second end cap 1150. A difference between the cane holding assembly 100 and the cane holding assembly 1100 is that first arm 1120 and the second arm 1130 are integrally formed in a single body, shown as an arm body 1160.

Similar to the cane holding assembly 100, the cane holding assembly 1100 is structured to receive a non-planar object, such as a cane, a broom handle, a flag stick, a golf club, or any variety of objects having a cylindrical or otherwise non-planar shaft or component. Generally speaking, a non-planar object may be biased toward the main body 1110 between the first end cap 1140 and the second end cap 1150. An inherent compliance of the first and second end caps 1140, 1150 applies a force on the non-planar object, holding the non-planar object within the cane holding assembly 1100. The non-planar object may also be removed from the cane holding assembly by biasing the non-planar object away from the main body 1110 and between the first and second end caps 1140, 1150. The inherent compliance of the first and second end caps 1140, 1150 may apply a force against the non-planer object in a direction generally toward the main body 1110 (e.g., against the direction the non-planar object is biased), but the force is not great enough to prevent the non-planar object from being biased (e.g., by a user) out of and away from the main body 1110, and thus out of and away from the cane holding assembly 1100.

The main body 1110 may be a single, integral body formed of a rigid or semi-rigid material, such as plastic, epoxy, resin, thermoset polymers, metal, alloys, wood, glass, and similar materials. In some embodiments, the main body 1110 is manufactured by bending a solid, straight metal bar about a middle section (e.g., near the middle, approximately near the middle, etc.), corresponding to a top portion 1200, and about two side portions, shown as a first side 1210 and a second side 1220.

The arm body 1160 extends between the first arm 1120 and the second arm 1130. More specifically, the arm body 1160 extends up the first side 1210, across the top portion 1200, and down the second side 1220 until the arm body 1160 meets again with the second arm 1130. The portion of the arm body 1160 that extends along the first side 1210 is between 1 and 3 inches in length, inclusive. In some embodiments, these portions are 1.5 to 2.5 inches in length, inclusive. In some embodiments, the portion of the arm body 1160 that extends along the first side 1210 and the second side 1220 measure 2 inches in length. The portion of the arm body 1160 that extends along the top portion 1200 may measure between 1 and 2 inches in length. In some embodiments, the portion of the arm body 1160 that extends along the top portion 1200 measures 1.375 inches in length.

The arm body 1160, and thus the first arm 1120 and the second arm 1130, extend below the main body 1110. The first arm 1120 and the second arm 1130 then bend and extend away from the main body 1110 in a direction generally perpendicular to the main body 1110. The first arm 1120 and the second arm 1130 are separated by approximately 1.25 inches.

The first end cap 1140 and the second end cap 1150 are similar to the first end cap 140. The first end cap 1140 includes a plurality of teeth, one of the plurality of teeth shown as a cap tooth 1300. The cap tooth 1300 may be hollow (e.g., a hollow tube), or may be solid. The cap tooth 1300 is configured to interface with a cane biased in and out of the cane holding assembly 1100. Whether or not the cap tooth 1300 is hollow or solid may affect the compliance of the ends caps 1140, 1150, and thus affect the force required to insert and remove a cane into and out of the cane holding assembly 1100.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The foregoing description of embodiments of the present invention have been presented for purposes of illustration and description. The foregoing description is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A cane holding assembly comprising:
a main body comprising a front portion;
a first arm and a second arm coupled to the front portion and extending away from the front portion;
a first end cap coupled to the first arm at a first arm end opposite the front portion; and
a second end cap coupled to the second arm at a second arm end opposite the front portion.

2. The cane holding assembly of claim 1, further comprising:
a first knob coupled to the first arm end and configured to interface with the first end cap; and
a second knob coupled to the second arm end and configured to interface with the second end cap.

3. The cane holding assembly of claim 2, further comprising:
a first projection positioned at a first cap inner surface of the first end cap, the first projection interfacing with the first knob to inhibit movement of the first end cap away from the first knob; and
a second projection positioned at a second cap inner surface of the second end cap, the second projection interfacing with the second knob to inhibit movement of the second end cap away from the second knob.

4. The cane holding assembly of claim 1, wherein the first arm further comprises a first joint portion, the first joint portion facilitating extension of the first arm end parallel to the front portion; and wherein the second arm further comprises a second joint portion, the second joint portion facilitating extension of the second arm end parallel to the front portion and parallel to the first arm end.

5. The cane holding assembly of claim 2, wherein the first knob and the second knob are positioned between 0.25 and 0.5 inches, inclusive, from the front portion.

6. The cane holding assembly of claim 1, wherein the main body is configured to be coupled to a vertical surface.

7. The cane holding assembly of claim 1, wherein the main body defines a clip having a rear portion and a joint portion.

8. A cane holding assembly comprising:
a main body having a front portion;
a first arm having a first end and a second end opposite the first end, the first end coupled to the front portion;
a first knob coupled to the first arm proximate the second end; and
a first end cap rotatably coupled to the first arm proximate the second end.

9. The cane holding assembly of claim 8, wherein the first end cap further comprises a plurality of projections, the plurality of projections positioned radially around an inner surface of the first end cap, the inner surface defining a first diameter and the plurality of projections defining a second diameter, wherein the plurality of projections interface with the first knob to inhibit translational movement of the first end cap away from the first knob.

10. The cane holding assembly of claim 9, wherein the first knob defines a knob diameter less than the first diameter and greater than the second diameter.

11. The cane holding assembly of claim 8, wherein the first end cap further comprises cap teeth, the cap teeth defining a third diameter, the third diameter between 0.5 and 1 inches, inclusive.

12. The cane holding assembly of claim 8, wherein the main body further comprises a rear portion, wherein an inherent compliance of the main body is configured to facilitate the movement of the front portion toward the rear portion to pinch an object positioned between the front portion and the rear portion.

13. A cane holding assembly comprising:
a main body having a front portion and a rear portion cooperating to form a clip;
a first arm coupled to the front portion and having a first knob; and
a first end cap positioned over the first knob such that the first end cap is rotatable relative to the first arm.

14. The cane holding assembly of claim 13, wherein the first arm comprises:
a first arm first portion extending orthogonally away from the front portion;
a first arm second portion extending parallel to the front portion; and
a first arm joint portion extending between the first arm first portion and the first arm second portion.

15. The cane holding assembly of claim 14, wherein the first knob is positioned at an end of the first arm second portion.

16. The cane holding assembly of claim 13, further comprising:
a second arm coupled to the front portion and having a second knob;
a second end cap positioned over the second knob such that the second end cap is rotatable relative to the second arm.

17. The can holding assembly of claim 16, wherein the first end cap includes a plurality of first teeth extending radially away from the first end cap; and
the second end cap includes a plurality of second teeth extending radially away from the second end cap.

18. The cane holding assembly of claim 16, wherein:
the first end cap includes a cap projection extending radially inward from the first end cap and configured to resist removal of the first knob from the first end cap; and
the second end cap includes a second cap projection extending radially inward from the second end cap and configured to resist removal of the second knob from the second end cap.

19. The cane holding assembly of claim 16, further comprising an arm body that defines both the first arm and the second arm, the arm body extending about a partial perimeter of the front such that the first arm and the second arm are formed from a single body.

20. The cane holding assembly of claim 13, wherein the first end cap is formed of a compliant material.
